(19) United States
(12) Patent Application Publication
(10) Pub. No.: US 2026/0081843 A1
(43) Pub. Date: Mar. 19, 2026

(54) DATA AND ANALYTICS BASED ON INTERNAL WIRELESS COMMUNICATIONS SYSTEM DATA AND EXTERNAL DATA

(71) Applicant: Lenovo (Singapore) Pte. Limited, Singapore (SG)

(72) Inventor: Ishan Vaishnavi, München (DE)

(73) Assignee: Lenovo (Singapore) Pte. Limited, Singapore (SG)

(21) Appl. No.: 19/108,388

(22) PCT Filed: Sep. 7, 2023
(86) PCT No.: PCT/IB2023/058880

§ 371 Date: Mar. 3, 2025

Related U.S. Application Data
(60) Provisional application No. 63/404,937, filed on Sep. 8, 2022.

(51) Int. Cl. H04L 41/14; H04L 41/122

(52) U.S. Cl. CPC H04L 41/145; H04L 41/122

(57) ABSTRACT

Various aspects of the present disclosure relate to generating data and analytics based at least in part on both internal wireless communications system data and on external data. The internal wireless communications system data is, for example, internal data of the wireless communications system that describes operation of the wireless communications system. The external data is, for example, data external to the wireless communications system that the apparatus has access to (e.g., data that the wireless communications system accesses with authentication from an owner of the external data, publicly available data, and so forth). An entity of the wireless communications system receives requests from a 3rd party consumer, generates the requested data and analytics, and returns the requested data to the 3rd party consumer.

### RELATED APPLICATION

This application claims priority to U.S. patent application Ser. No. 63/404,937 filed Sep. 8, 2022 entitled “Data and Analytics Based on Internal Wireless Communications System Data and External Data,” the disclosure of which is incorporated by reference herein in its entirety.

### TECHNICAL FIELD

The present disclosure relates to wireless communications, and more specifically to data and analytics based on internal wireless communications system data and external data.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A wireless communications system generates various analytics regarding the wireless communications system. These analytics are used for fixing network issues or improving service quality.

### SUMMARY

The present disclosure relates to methods, apparatuses, and systems that support generating data and analytics based at least in part on both internal wireless communications system data and on external data. The internal wireless communications system data is, for example, internal data of the wireless communications system that describes operation of the wireless communications system. The external data is, for example, data external to the wireless communications system that the apparatus has access to (e.g., data that the wireless communications system accesses with authentication from an owner of the external data, publicly available data, and so forth). By using both the internal wireless communications system data and the external data, the wireless communications system can provide data and services to other entities (e.g., devices or other consumers) that make use of data that would otherwise be unavailable to the wireless communications system.

Some implementations of the method and apparatuses described herein may further include to receive, from a requesting device, a first signaling indicating a request for first data or analytics; and transmit, to the requesting device, a second signaling indicating the first data or analytics based at least in part on both internal data of a wireless communications system and external data the apparatus has access to.

In some implementations of the method and apparatuses described herein, the methods and apparatuses described herein may further include to select one or more data sources of second data to use to satisfy the request; transmit, to each of the one or more data sources, a third signaling indicating a request for the second data from the data source; and receive, from each of the one or more data sources, a fourth signaling indicating the second data. Additionally or alternatively, the one or more data sources include at least one of a network data analytics function (NWDAF), a management data analytics management services (MDAS), an operations and management (OAM) entity, a data source internal to the wireless communication system, a data source external to the wireless communication system, a network slice instance, a network slice subnet instance, a network function (NF), a virtualization system, a data source belonging to legal entities separated from a mobile network operator. Additionally or alternatively, the methods and apparatuses described herein may further include to identify, based at least in part on the first data or analytics, a service that can be provided; and transmit, to the requesting device, a third signaling indicating that the service is available for consumption. Additionally or alternatively, the methods and apparatuses described herein are collocated with an NWDAF, an MDAS, an OAM entity, or another NF in the wireless communications system. Additionally or alternatively, the requesting device is external to the wireless communications system and the processor is further configured to generate the first data or analytics by combining the internal data and the external data. Additionally or alternatively, the methods and apparatuses described herein may further include to determine, based at least in part on the first data as well as a type of data access used to obtain the first data, a charge for the first data or analytics; and transmit, to the requesting device, an indication of the charge for the first data or analytics. Additionally or alternatively, the apparatus further comprises an application that configures the processor to receive the first signaling and transmit the second signaling.

Some implementations of the method and apparatuses described herein may further include to transmit, to a device in a wireless communications system, a first signaling indicating a request for first data or analytics; and receive, from the device, a second signaling indicating the first data or analytics based at least in part on both internal data of the wireless communications system and external data the device has access to.

In some implementations of the method and apparatuses described herein, the first data or analytics is based on data gathered by the device from multiple data sources. Additionally or alternatively, the multiple data sources include at least one of an NWDAF, an MDAS, an OAM entity, a data source internal to the wireless communication system, a data source external to the wireless communication system, a network slice instance, a network slice subnet instance, an NF a virtualization system, one or more data sources belonging to legal entities separated from a mobile network operator. Additionally or alternatively, the methods and apparatuses described herein may further include to receive, from the device, a third signaling indicating that a service is available for consumption based at least in part on the first data or analytics; and transmit, to the device, a fourth signaling invoking the service. Additionally or alternatively, the device is collocated with an NWDAF, an MDAS, an OAM entity, or another NF in the wireless communications system. Additionally or alternatively, the methods and apparatuses described herein may further be external to the wireless communications system and the first data or analytics are a combination of the internal data and the external data. Additionally or alternatively, the methods and apparatuses described herein may further include to receive, from the device, an indication of a charge for the first data or analytics based at least in part on the first data as well as a type of data access used to obtain the first data.

### BRIEF DESCRIPTION OF THE DRAWINGS

FIG. 1 illustrates an example of a wireless communications system that supports data and analytics based on internal wireless communications system data and external data in accordance with aspects of the present disclosure.

FIG. 2 illustrates an example system for deriving and providing analytics to analytics consumer NFs that supports data and analytics based on internal wireless communications system data and external data in accordance with aspects of the present disclosure.

FIG. 3 illustrates an example architecture showing a management data analytics (MDA) functional overview and service framework that supports data and analytics based on internal wireless communications system data and external data in accordance with aspects of the present disclosure.

FIG. 4 illustrates an example illustrating use of the data and analytics based on internal wireless communications system data and external data in accordance with aspects of the present disclosure.

FIG. 5 illustrates a signaling diagram illustrating use of the data and analytics based on internal wireless communications system data and external data in accordance with aspects of the present disclosure.

FIGS. 6 and 7 illustrate an example of a block diagram of a device that supports data and analytics based on internal wireless communications system data and external data in accordance with aspects of the present disclosure.

FIGS. 8 through 11 illustrate flowcharts of methods that support data and analytics based on internal wireless communications system data and external data in accordance with aspects of the present disclosure.

### DETAILED DESCRIPTION

The techniques discussed herein relate to methods, apparatuses, and systems that support generating data and analytics based at least in part on both internal wireless communications system data and on external data. The internal wireless communications system data is, for example, internal data of the wireless communications system that describes operation of the wireless communications system. The external data is, for example, data external to the wireless communications system that the apparatus has access to (e.g., data that the wireless communications system accesses with authentication from an owner of the external data, publicly available data, and so forth).

External data sources, such as a network slice or a communication service instance, allows data sharing with the operator of the wireless communications system (e.g., a mobile network operator) and allows the operator to use this data to enhance services. An entity receives a request for data or analytics, determines which data sources are relevant to the received request, and requests that data from one or more data sources for analysis. These one or more data sources provide external data and internal data available to the operator.

For example, the entity that receives the request from a consumer (e.g., an individual, a device, an application, a service, and so forth) may figure that for a given information request the data relevant to a network slice instance (NSI) on vehicular slicing, as well as an NSI on energy production, is relevant. The entity can then contact those one or more data sources (the NSIs) to fetch this data and use the fetched data to generate the data or analytics to satisfy the request from the consumer.

Thus, an operator of a wireless communications system can pursue network slicing solutions from different vertical customers, and can collect data from those customers. Examples of such data include how much energy is an energy company's energy grid producing, what is the weather in a certain area in the next hour, how many vehicles are likely to be in a given section of road in the coming 4 hours, and so forth. Such data is known to the operator and the vertical entity using the NSI. Using this data, the operator can offer newer services to other vertical customers while sharing the revenue with the data providers.

Some wireless communications systems enable analytics in both control and management planes. However, these analytics are used for fixing network issues or improving service quality. The techniques discussed herein, on the other hand, allow such analytics to be used to provide new services, create new business opportunities, and so forth. The techniques discussed herein allow the operator of the wireless communications system to use the immense data they have on their end consumers, with the authorization or permission of their end consumers, beyond network and service quality issues. Furthermore, the techniques discussed herein allow the operator of the wireless communications system to provide such analytics, data, services, and so forth without requiring an operations and management (OAM) entity of the wireless communications system to expose internal services or data to the various data sources (e.g., to the people, companies, or businesses using a particular NSI). The techniques discussed herein thus allow services provided by the operator to be expanded while keeping internal services or data of the operator secure.

Aspects of the present disclosure are described in the context of a wireless communications system. Aspects of the present disclosure are further illustrated and described with reference to device diagrams and flowcharts.

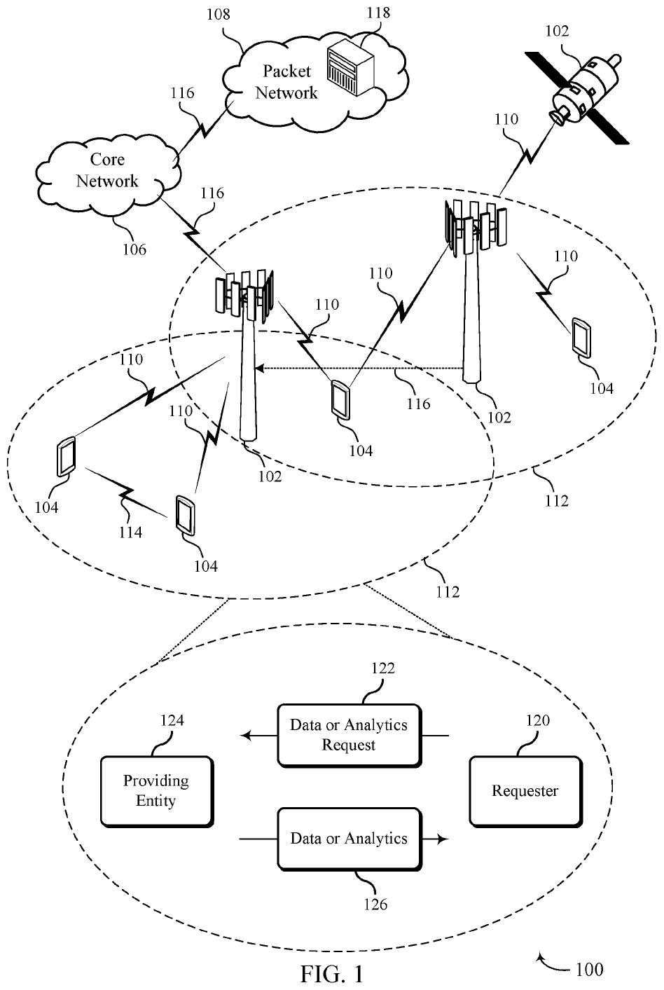

FIG. 1 illustrates an example of a wireless communications system 100 that supports data and analytics based on internal wireless communications system data and external data in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1.

Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one or more implementations, the wireless communications system 100 supports network slicing. Network slicing refers to a network architecture in which multiple logical networks are multiplexed on a physical network infrastructure. The different network slices (also referred to as simply slices) can be suited to different use cases, such as supporting different quality of service (QoS) levels or requirements. For example, one network slice may be suited to high bandwidth, another network slice may be suited to low latency, another network slice may be suited to having a vary large number of connected devices, and so forth. A network slice includes one or more or network slice instances (NSIs) that can be made available to various consumers. This allows, for example, a consumer to use one or more NSIs from each of one or more network slices.

A requester 120 transmits a data or analytics request 122 to a providing entity 124. The providing entity 124 determines one or more data sources from which to obtain data to satisfy the request 122, contacts those one or more data sources for the data to satisfy the request 122. The one or more data sources may include data sources that provide internal data, such as data that describes operation of the wireless communications system 100, data from a control plane or management plane of the wireless communications system 100, data from an OAM entity in the wireless communications system 100, and so forth. The one or more data sources may also include data sources that provide external data, such as data that does not describe the operation of the wireless communications system 100. Examples of external data include data that the wireless communications system 100 accesses with authentication or permission from an owner of the data, publicly available data, and so forth.

The providing entity uses the data from the one or more data sources to generate the requested data or analytics 126, and provides the requested data or analytics 126 to the requester 120. The requested data or analytics 126 may also be referred to as combined data or combined analytics as the requested data or analytics 126 may be generated based on both internal data and external data. In one or more implementations, the providing entity 124 signals or otherwise identifies to the requester 120 one or more different services that the providing entity 124 has available for consumption. The data or analytics request 122 may be communicated by invoking or otherwise accessing a service made available by the providing entity 124.

In one or more implementations, the providing entity 124 identifies, based on the data received from the one or more data sources (e.g., external data), one or more additional services to provide or make available to the requester 120. The providing entity 124 can communicate an indication to the requester 120 that one or more such additional services are available for consumption. For example, in accessing the one or more data sources the providing entity 124 may discover that data regarding current weather in a particular city is available. The providing entity may then enable an additional service, and notify the requester 120 that such additional service is available for consumption, such as a service to launch a drone to monitor crops under particular weather conditions, a service to receive crowd information obtained from cameras monitoring popular tourist locations under particular weather conditions, and so forth.

The providing entity 124 may be any of a variety of different devices, modules, functions, network functions, and so forth. In one or more implementations, the providing entity 124 is included in the core network 106. The providing entity 124 may be a fixed entity (e.g., a particular entity within the core network 106) or a variable entity (e.g., different entities within the core network 106 may be the providing entity 124 based on the data or analytics request 122, with different entities responding to requests for different types of data or analytics). The requester 120 may also be any of a variety of different devices, modules, network functions, NSIs, and so forth. Although illustrated as part of the wireless communications system 100, it should be noted that the requester 120 need not be internal to the core network 106 and may communicate with the providing entity 124 via one or more intermediary devices such as a base station.

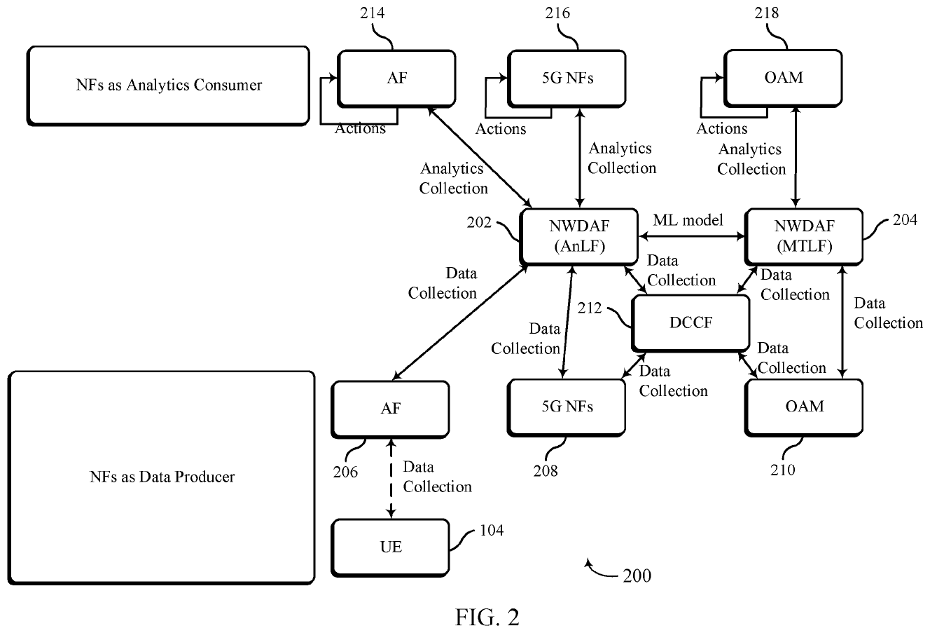

FIG. 2 illustrates an example system 200 for deriving and providing analytics to analytics consumer network functions (NFs) that supports data and analytics based on internal wireless communications system data and external data in accordance with aspects of the present disclosure. The system 200 includes an NWDAF that is made up of an analytical logical function (AnLF) 202 and a model training logical function (MTLF) 204. The NWDAF collects data from one or more of various sources, also referred to as data producers or data producer network functions (NFs), such as an application function (AF) 206, a UE 104, an NF 208, an OAM entity 210, and a data collection coordination function (DCCF) 212. The NWDAF provides analytic output to one or more requesters, also referred to as analytics consumers or analytics consumer NFs, based on the collected data. These requesters include, for example, an AF 214, an NF 216, and an OAM entity 218. Accordingly, various NFs may be analytics consumers, data producers, or both analytics consumers and data producers.

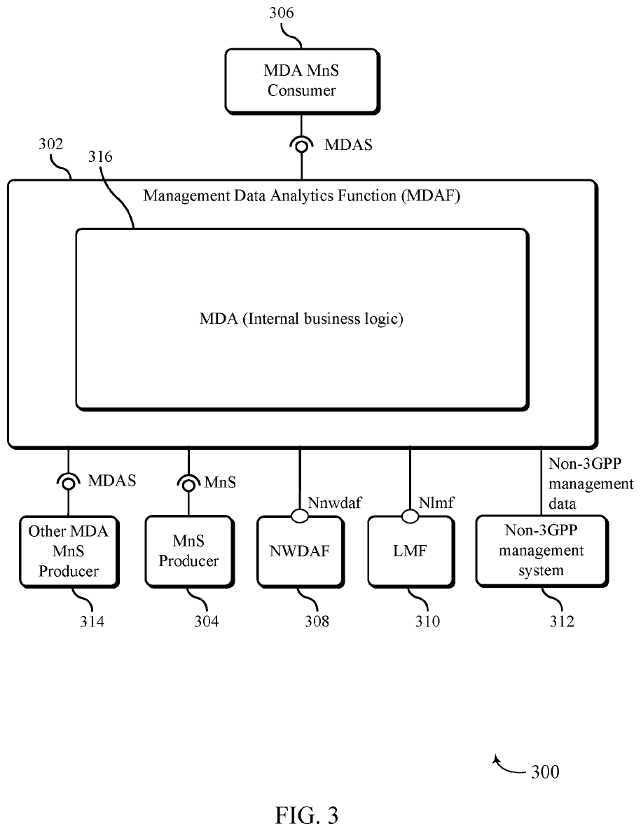

FIG. 3 illustrates an example architecture 300 showing a management data analytics (MDA) functional overview and service framework that supports data and analytics based on internal wireless communications system data and external data in accordance with aspects of the present disclosure. Analytics may also be generated at the management plane as illustrated in the example architecture 300. MDA is an enabler of automation and intelligence for services management and orchestration. An MDA management services (MnS), also referred to as MDAS, such as defined in 3rd Generation Partnership Project (3GPP) technical specification (TS) 28.102 v2.0.0, enables any authorized consumer to request and receive analytics.

A management data analytics function (MDAF) 302 may play the roles of MDA MnS producer 304, MDA MnS consumer 306, other MnS consumer, NWDAF 308 consumer and LMF 310 service consumer, other MnS producer 312, and may also interact with other non-3GPP management systems 314.

The internal business logic 316 related to MDA leverages the current and historical data related to, for example, one or more of: performance measurements (PM) as per 3GPP TS 28.552 and key performance indicators (KPIs) as per 3GPP TS 28.554; trace data, including minimization of drive testing (MDT)/radio link failure (RLF)/radio resource control (RRC) connection establishment failure (RCEF), as per 3GPP TS 32.422 and 3GPP TS 32.423; quality of experience (QoE) and service experience data as per 3GPP TS 28.405 and 3GPP TS 28.406; analytics data offered by NWDAF as per 3GPP TS 23.288 including 5GC data and external web/app-based information (e.g., web crawler that provides online news) from AF; alarm information and notifications as per 3GPP TS 28.532; connection management (CM) information and notifications; UE location information provided by LMF as per 3GPP TS 23.273; MDA reports from other MDA MnS producers; and management data from non-3GPP systems.

Analytics output from the MDA internal business logic 316 are made available by the management functions (MDAFs) playing the role of MDA MnS producers to the authorized consumers, (including but not limited to other management functions, network functions/entities, NWDAF, SON functions, optimization tools and human operators).

The analytics provided by MDAS include analytics for fault management predictions/statistics or generally the MDA can assist in fault management. The MDA can supervise the status of various network functions and resources, and predict the running trend of network and potential failures to intervene in advance. These predictions can be used by the management system to autonomously maintain the health of the network, e.g., speedy recovery actions on a network function related to the predicted potential failure.

In one or more implementations, the term “external management data” or “external data” relates to data not specified by 3GPP. Examples of external data are weather conditions in the coverage area of a cell, or land-usage-land-coverage data in the coverage area of a cell.

The techniques discussed herein support various scenarios, such as the following. An operator or an application owner can create an application that allows 3rd parties to use data analytics services that combine internal and external data sources. For example, an energy company may use the weather information in a particular area to calculate the energy production requirement for that area. A green energy production company may use the energy production information as well as the weather information to decide whether to sell the energy on a grid or to store the energy. A fuel transportation company may decide on the dynamic fuel pricing and transportation needs based on vehicular traffic predictions from a vehicle to everything (V2X) slice.

In one or more implementations, from one perspective, the techniques discussed herein transform the operator into a platform operator instead of a service provider, which can lead to data or services being provided, new sources of revenue, and so forth.

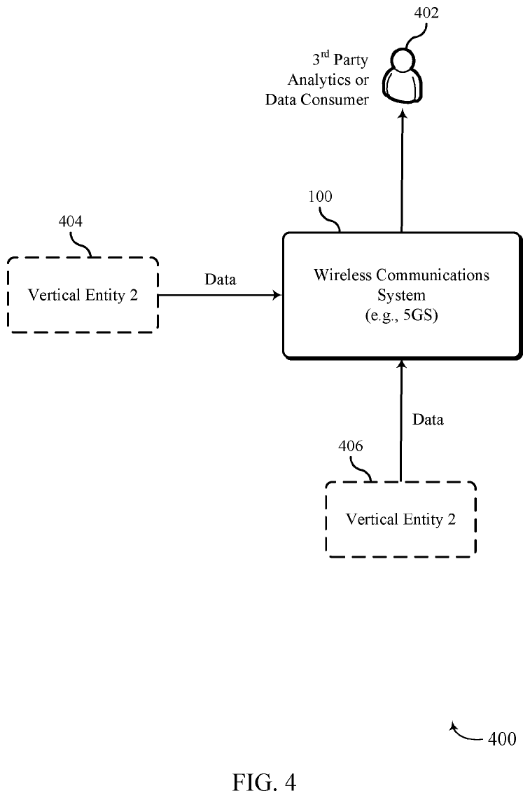

FIG. 4 illustrates an example 400 illustrating use of the data and analytics based on internal wireless communications system data and external data in accordance with aspects of the present disclosure. The example 400 illustrates a 3^{rd} party consumer 402 using, via the wireless communications system 100, analytics and data from multiple vertical entities 404 and 406. These vertical entities may be any data sources discussed herein, such as a NSI, a NF, and so forth.

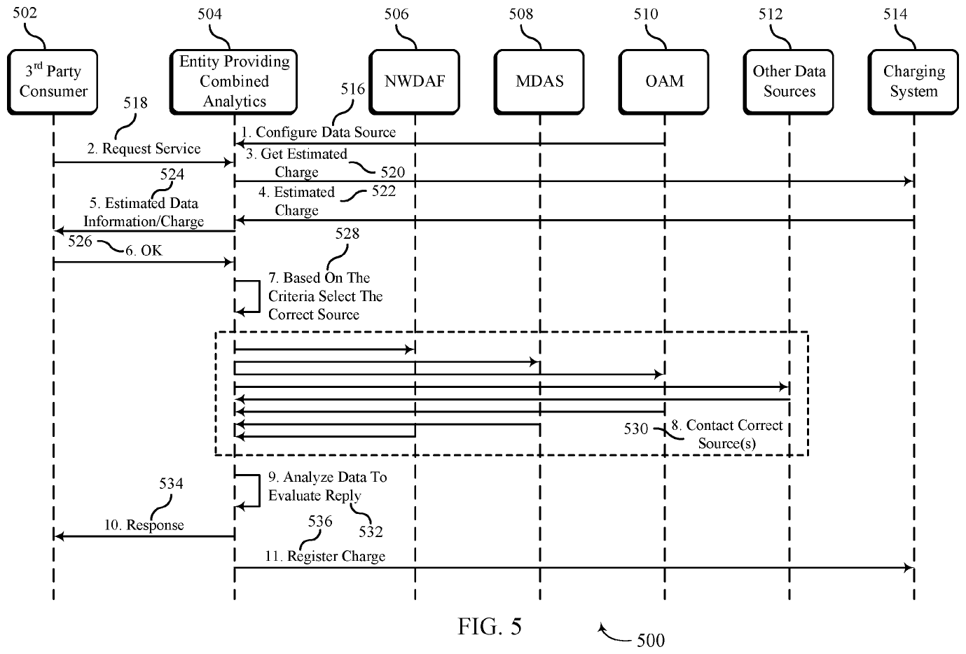

FIG. 5 illustrates a signaling diagram 500 illustrating use of the data and analytics based on internal wireless communications system data and external data in accordance with aspects of the present disclosure. The signaling diagram 500 includes a 3^{rd} party consumer 502 (e.g., a requester 120 of FIG. 1), an entity providing combined analytics 504 (e.g., a providing entity 124 of FIG. 1 that provides data and analytics), an NWDAF 506, an MDAS 508, an OAM 510, other data sources 512 (e.g., internal or external to the operator (e.g., the wireless communications system 100 of FIG. 1), such as an NSI, and a charging system 514 (e.g., a charging enablement function (CEF) or a charging function (CHF)).

The signaling diagram 500 assumes that vertical consent for access and usage of vertical data by the operator network (e.g., the wireless communications system 100 of FIG. 1) exists and is pre-negotiated. Accordingly, it is assumed that the operator network has obtained permission or authorization to use any external data that is owned by another entity (e.g., another company, individual, and so forth), which is also referred to herein as a vertical.

Step 1. At 516, based on the agreement between the vertical and the operator, the OAM 510 configures address and access for the entity providing combined analytics 504 to access one or more external data sources.

Step 2. At 518, the 3rd party consumer 502 requests a data, analytics or artificial intelligence (AI) service, or any other service that may in turn use data, analytics or an AI service, for a certain category of users. The 3rd party consumer 502 can be any one of an NSI, an application, another data source, a vertical entity (e.g., a person or software), any external consumer, or any combination thereof.

Step 3. At 520, the entity providing the combined analytics 504 receives the request and estimates the probable charging requirements from the charging system, such as the charging enablement function (CEF) or the charging function (CF). This charging indicates, for example, one or more of an amount of data to be transferred to satisfy the request, a payment, and so forth.

Step 4. At 522, the estimated charge is then indicated to the entity providing the combined analytics 504. The estimated charge can be, for example, the actual charge, the details of how the charging is done for the given service request, and so forth.

Step 5. At 524, the estimated meta information about the service requested and the charging information from step 3 is forwarded to the 3rd party consumer 502.

Step 6. At 526, the 3rd party consumer 502 may take one or more actions, such as approve the charge, choose a different service (e.g., returning to step 1), or change the service (add or delete the details of the service). This data (e.g., details of the service) may also be provided in step 1. The final service request confirmation is then sent to the entity providing the combined analytics 504.

Step 7. At 528, the entity providing the combined analytics 504 decides which sources to contact to receive the data or other data which can be used to derive the requested data/analytics or service result, including external data sources.

Step 8. At 530, the entity providing combined analytics 504 contacts those data sources decided on in step 7, which includes, for example, the NWDAF 506, the MDAS 508, the OAM 510, or any internal or external data source 512 as configured in Step 1 by the OAM 510. As an example of an external data source, it may contact a weather sensor provider to get the sensor installed in a certain area to get the sensor reading when, for example, weather data from a location is required.

Step 9. At 532, based on the collected data the entity providing combined analytics 504 can calculate the final service result that meet the 3^{rd} party consumer 502 provided criteria.

Step 10. At 534, the final service result is provided to the 3rd party consumer 502.

Step 11. At 536, a corresponding charge is registered with the charging system 514 for the 3rd party consumer 502. This creates, for example, a charging record with the charging system 514.

It should be noted that the service request from the operator could also go via another service providing entity to the entity providing combined analytics 504.

The ability of the operator (e.g., of the wireless communications system 100 of FIG. 1) to allow third party consumers to use services offered by the operator by leveraging the operator's relationship to other vertical industries allows the creation of a platform (e.g., multi-sided market) enabling new sources of data, analytics, services, and revenue. The techniques discussed herein identify data that the operator could then capture by virtue of hosting 3rd party NSI and additionally also application-level data with permission from the vertical entity. Using data from multiple vertical entities the operator is in a key position to provide value added data services combining such data that no other firm could possibly do. This is made possible by the entity providing combined analytics, which can combine analytics from both management and control planes, in addition to other data source internal and external to the operator.

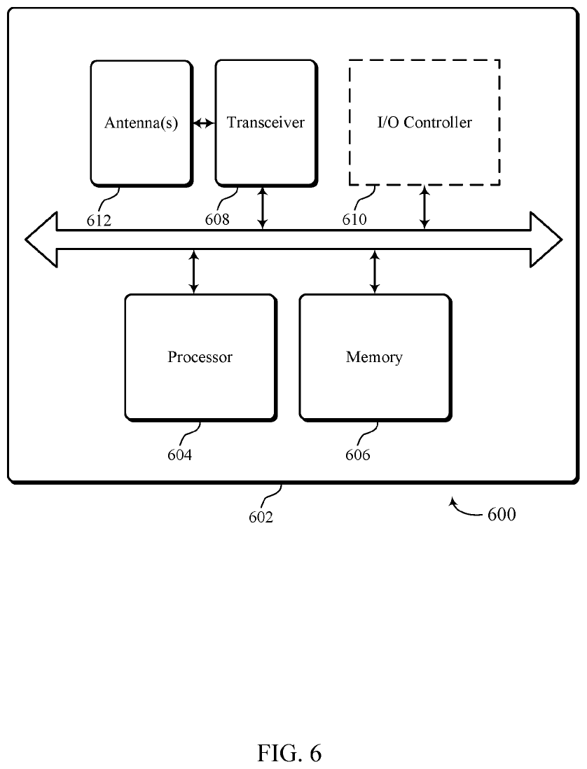

FIG. 6 illustrates an example of a block diagram 600 of a device 602 that supports data and analytics based on internal wireless communications system data and external data in accordance with aspects of the present disclosure. The device 602 may be an example of a providing entity 124 (e.g., an entity in the core network 106 of FIG. 1) as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. Processor 604 may be configured as or otherwise support receive, from a requesting device, a first signaling indicating a request for first data or analytics; and transmit, to the requesting device, a second signaling indicating the first data or analytics based at least in part on both internal data of a wireless communications system and external data the apparatus has access to.

Additionally or alternatively, the processor 604 may be configured to or otherwise support: select one or more data sources of second data to use to satisfy the request; transmit, to each of the one or more data sources, a third signaling indicating a request for the second data from the data source; and receive, from each of the one or more data sources, a fourth signaling indicating the second data; where the one or more data sources include at least one of an NWDAF, an MDAS, an OAM entity, a data source internal to the wireless communication system, a data source external to the wireless communication system, a network slice instance, a network slice subnet instance, an NF, a virtualization system, a data source belonging to legal entities separated from a mobile network operator; where the processor is further configured to: identify, based at least in part on the first data or analytics, a service that can be provided; and transmit, to the requesting device, a third signaling indicating that the service is available for consumption; where the apparatus is collocated with an NWDAF, an MDAS, an OAM entity, or another NF in the wireless communications system; where the requesting device is external to the wireless communications system and the processor is further configured to generate the first data or analytics by combining the internal data and the external data; where the processor is further configured to: determine, based at least in part on the first data as well as a type of data access used to obtain the first data, a charge for the first data or analytics; and transmit, to the requesting device, an indication of the charge for the first data or analytics; where the apparatus further comprises an application that configures the processor to receive the first signaling and transmit the second signaling.

For example, the processor 604 may support wireless communication at the device 602 in accordance with examples as disclosed herein. Processor 604 may be configured as or otherwise support a means for receiving, from a requesting device, a first signaling indicating a request for first data or analytics; and transmitting, to the requesting device, a second signaling indicating the first data or analytics based at least in part on both internal data of a wireless communications system and external data an apparatus implementing the method has access to.

Additionally or alternatively, the processor 604 may be configured to or otherwise support: further including: selecting one or more data sources of second data to use to satisfy the request; transmitting, to each of the one or more data sources, a third signaling indicating a request for the second data from the data source; and receiving, from each of the one or more data sources, a fourth signaling indicating the second data; where the one or more data sources include at least one of an NWDAF, an MDAS, an OAM entity, a data source internal to the wireless communication system, a data source external to the wireless communication system, a network slice instance, a network slice subnet instance, an NF, a virtualization system, a data source belonging to a legal entity separate from a mobile network operator; further including: identifying, based at least in part on the first data or analytics, a service that can be provided; and transmitting, to the requesting device, a third signaling indicating that the service is available for consumption; where the apparatus is collocated with an NWDAF, an MDAS, an OAM entity, or another NF in the wireless communications system; where the requesting device is external to the wireless communications system and the method further including generating the first data or analytics by combining the internal data and the external data; further including: determining, based at least in part on the first data as well as a type of data access used to obtain the first data, a charge for the first data or analytics; and transmitting, to the requesting device, an indication of the charge for the first data or analytics; where the method is implemented by an application of the apparatus.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

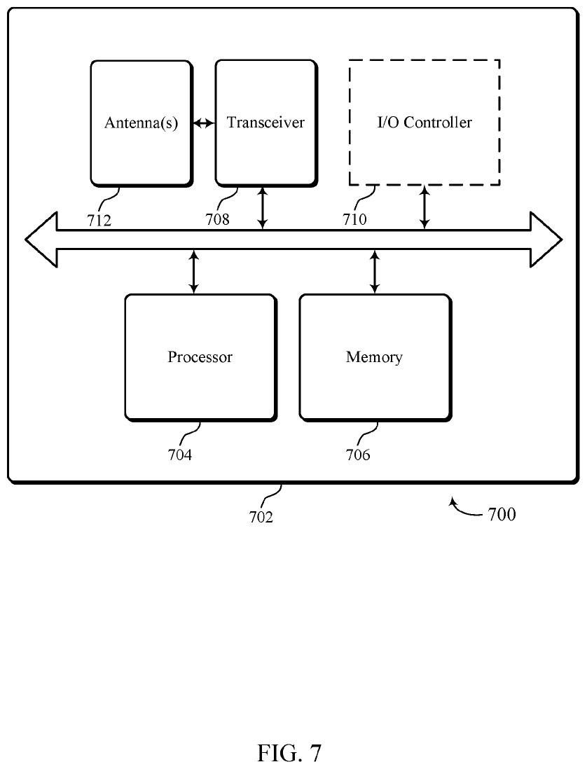

FIG. 7 illustrates an example of a block diagram 700 of a device 702 that supports data and analytics based on internal wireless communications system data and external data in accordance with aspects of the present disclosure. The device 702 may be an example of a requester 120 (e.g., a UE 104 or other device) as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. Processor 704 may be configured as or otherwise support transmit, to a device in a wireless communications system, a first signaling indicating a request for first data or analytics; and receive, from the device, a second signaling indicating the first data or analytics based at least in part on both internal data of the wireless communications system and external data the device has access to.

Additionally or alternatively, the processor 704 may be configured to or otherwise support: where the first data or analytics is based on data gathered by the device from multiple data sources; where the multiple data sources include at least one of an NWDAF, an MDAS, an OAM entity, a data source internal to the wireless communication system, a data source external to the wireless communication system, a network slice instance, a network slice subnet instance, an NF a virtualization system, one or more data sources belonging to legal entities separated from a mobile network operator; where the processor is further configured to: receive, from the device, a third signaling indicating that a service is available for consumption based at least in part on the first data or analytics; and transmit, to the device, a fourth signaling invoking the service; where the device is collocated with an NWDAF, an MDAS, an OAM entity, or another NF in the wireless communications system; where the apparatus is external to the wireless communications system and the first data or analytics are a combination of the internal data and the external data; where the processor is further configured to: receive, from the device, an indication of a charge for the first data or analytics based at least in part on the first data as well as a type of data access used to obtain the first data.

For example, the processor 704 may support wireless communication at the device 702 in accordance with examples as disclosed herein. Processor 704 may be configured as or otherwise support a means for transmitting, to a device in a wireless communications system, a first signaling indicating a request for first data or analytics; and receiving, from the device, a second signaling indicating the first data or analytics based at least in part on both internal data of the wireless communications system and external data the device has access to.

Additionally or alternatively, the processor 704 may be configured to or otherwise support: where the first data or analytics is based on data gathered by the device from multiple data sources; where the multiple data sources include at least one of an NWDAF, an MDAS, an OAM entity, a data source internal to the wireless communication system, a data source external to the wireless communication system, a network slice instance, a network slice subnet instance, an NF, a virtualization system, data sources belonging to legal entities separate from a mobile network operator; further including: receiving, from the device, a third signaling indicating that a service is available for consumption based at least in part on the first data or analytics; and transmitting, to the device, a fourth signaling invoking the service; where the device is collocated with an NWDAF, an MDAS, an OAM entity, or another NF in the wireless communications system; where an apparatus implementing the method is external to the wireless communications system and the first data or analytics are a combination of the internal data and the external data; further including: receiving, from the device, an indication of a charge for the first data or analytics based at least in part on the first data as well as a type of data access used to obtain the first data.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

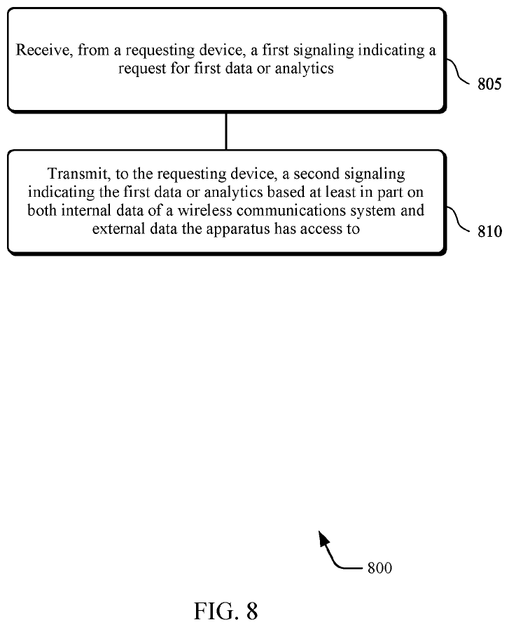

FIG. 8 illustrates a flowchart of a method 800 that supports data and analytics based on internal wireless communications system data and external data in accordance with aspects of the present disclosure. The operations of the method 800 may be implemented by a device or its components as described herein. For example, the operations of the method 800 may be performed by a providing entity 124 (e.g., an entity in the core network 106 of FIG. 1) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 805, the method may include receiving, from a requesting device, a first signaling indicating a request for first data or analytics. The operations of 805 may be performed in accordance with examples as described herein. In some implementations, aspects of the operations of 805 may be performed by a device as described with reference to FIG. 1.

At 810, the method may include transmitting, to the requesting device, a second signaling indicating the first data or analytics based at least in part on both internal data of a wireless communications system and external data the apparatus has access to. The operations of 810 may be performed in accordance with examples as described herein. In some implementations, aspects of the operations of 810 may be performed by a device as described with reference to FIG. 1.

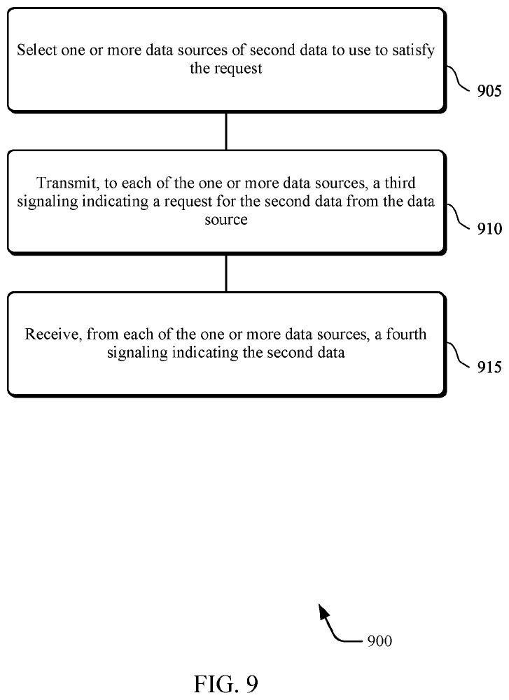

FIG. 9 illustrates a flowchart of a method 900 that supports data and analytics based on internal wireless communications system data and external data in accordance with aspects of the present disclosure. The operations of the method 900 may be implemented by a device or its components as described herein. For example, the operations of the method 900 may be performed by a providing entity 124 (e.g., an entity in the core network 106 of FIG. 1) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 905, the method may include selecting one or more data sources of second data to use to satisfy the request. The operations of 905 may be performed in accordance with examples as described herein. In some implementations, aspects of the operations of 905 may be performed by a device as described with reference to FIG. 1.

At 910, the method may include transmitting, to each of the one or more data sources, a third signaling indicating a request for the second data from the data source. The operations of 910 may be performed in accordance with examples as described herein. In some implementations, aspects of the operations of 910 may be performed by a device as described with reference to FIG. 1.

At 915, the method may include receiving, from each of the one or more data sources, a fourth signaling indicating the second data. The operations of 915 may be performed in accordance with examples as described herein. In some implementations, aspects of the operations of 915 may be performed by a device as described with reference to FIG. 1.

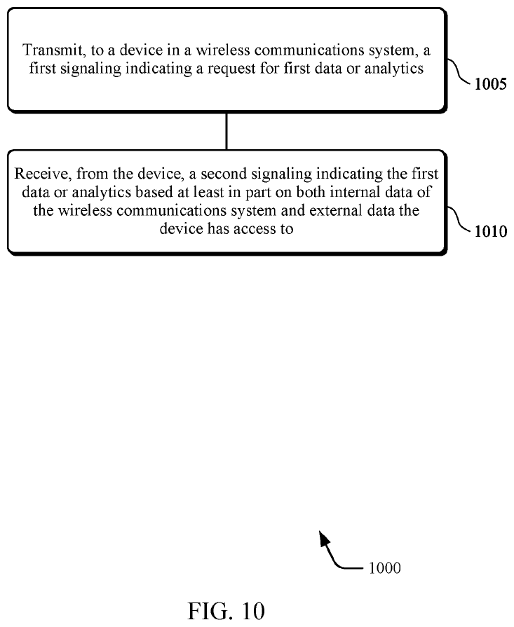

FIG. 10 illustrates a flowchart of a method 1000 that supports data and analytics based on internal wireless communications system data and external data in accordance with aspects of the present disclosure. The operations of the method 1000 may be implemented by a device or its components as described herein. For example, the operations of the method 1000 may be performed by a requester 120 (e.g., a UE 104 or other device) as described with reference to FIGS. 1 through 7. In some implementations, the device may execute a set of instructions to control the function. elements of the device to perform the described functions. Additionally, or alternatively, the device may perform aspects of the described functions using special-purpose hardware.

At 1005, the method may include transmitting, to a device in a wireless communications system, a first signaling indicating a request for first data or analytics. The operations of 1005 may be performed in accordance with examples as described herein. In some implementations, aspects of the operations of 1005 may be performed by a device as described with reference to FIG. 1.

At 1010, the method may include receiving, from the device, a second signaling indicating the first data or analytics based at least in part on both internal data of the wireless communications system and external data the device has access to. The operations of 1010 may be performed in accordance with examples as described herein. In some implementations, aspects of the operations of 1010 may be performed by a device as described with reference to FIG. 1.

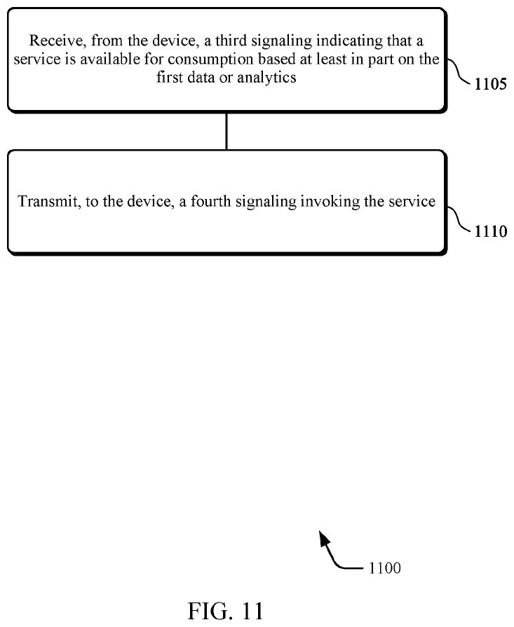

FIG. 11 illustrates a flowchart of a method 1100 that supports data and analytics based on internal wireless communications system data and external data in accordance with aspects of the present disclosure. The operations of the method 1100 may be implemented by a device or its components as described herein. For example, the operations of the method 1100 may be performed by a requester 120 (e.g., a UE 104 or other device) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1105, the method may include receiving, from the device, a third signaling indicating that a service is available for consumption based at least in part on the first data or analytics. The operations of 1105 may be performed in accordance with examples as described herein. In some implementations, aspects of the operations of 1105 may be performed by a device as described with reference to FIG. 1.

At 1110, the method may include transmitting, to the device, a fourth signaling invoking the service. The operations of 1110 may be performed in accordance with examples as described herein. In some implementations, aspects of the operations of 1110 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and configured to cause the apparatus to:
receive a first signaling indicating a request for first data or analytics; and
transmit a second signaling indicating the first data or analytics based at least in part on both internal data of a wireless communications system and external data the apparatus has access to.

2. The apparatus of claim 1, wherein the at least one processor is further configured to cause the apparatus to:
select one or more data sources of second data to use to satisfy the request;
transmit, to each of the one or more data sources, a third signaling indicating a request for the second data from the data source; and
receive, from each of the one or more data sources, a fourth signaling indicating the second data.

3. The apparatus of claim 2, wherein the one or more data sources include at least one of a network data analytics function (NWDAF), a management data analytics management services (MDAS), an operations and management (OAM) entity, a data source internal to the wireless communication system, a data source external to the wireless communication system, a network slice instance, a network slice subnet instance, a network function (NF), a virtualization system, a data source belonging to legal entities separated from a mobile network operator.

4. The apparatus of claim 1, wherein the at least one processor is further configured to cause the apparatus to:
identify, based at least in part on the first data or analytics, a service that can be provided; and
transmit a third signaling indicating that the service is available for consumption.

5. The apparatus of claim 1, wherein the apparatus is collocated with a network data analytics function (NWDAF), a management data analytics management services (MDAS), an operations and management (OAM) entity, or another network function (NF) in the wireless communications system.

6. The apparatus of claim 1, wherein to receive the first signaling, the at least one processor is further configured to cause the apparatus to receive the first signaling from a requesting device that is external to the wireless communications system, and the at least one processor is further configured to cause the apparatus to generate the first data or analytics by combining the internal data and the external data.

7. The apparatus of claim 1, wherein the at least one processor is further configured to cause the apparatus to:
determine, based at least in part on the first data as well as a type of data access used to obtain the first data, a charge for the first data or analytics; and
transmit an indication of the charge for the first data or analytics.

8. The apparatus of claim 1, wherein the apparatus further comprises an application that configures the processor to cause the apparatus to receive the first signaling and transmit the second signaling.

9. An apparatus for wireless communication, comprising:
at least one memory; and
at least one processor coupled with the at least one memory and configured to cause the apparatus to:
transmit a first signaling indicating a request for first data or analytics; and
receive, from a device in a wireless communications system, a second signaling indicating the first data or analytics based at least in part on both internal data of the wireless communications system and external data the device has access to.

10. The apparatus of claim 9, wherein the first data or analytics is based on data gathered by the device from multiple data sources.

11. The apparatus of claim 10, wherein the multiple data sources include at least one of a network data analytics function (NWDAF), a management data analytics management services (MDAS), an operations and management (OAM) entity, a data source internal to the wireless communication system, a data source external to the wireless communication system, a network slice instance, a network slice subnet instance, a network function (NF), a virtualization system, one or more data sources belonging to legal entities separated from a mobile network operator.

12. The apparatus of claim 9, wherein the at least one processor is further configured to cause the apparatus to:
receive a third signaling indicating that a service is available for consumption based at least in part on the first data or analytics; and
transmit a fourth signaling invoking the service.

13. The apparatus of claim 9, wherein the device is collocated with a network data analytics function (NWDAF), a management data analytics management services (MDAS), an operations and management (OAM) entity, or another network function (NF) in the wireless communications system.

14. The apparatus of claim 9, wherein the apparatus is external to the wireless communications system and the first data or analytics are a combination of the internal data and the external data.

15. The apparatus of claim 9, wherein the at least one processor is further configured to cause the apparatus to:
receive an indication of a charge for the first data or analytics based at least in part on the first data as well as a type of data access used to obtain the first data.

16. A method, comprising:
receiving a first signaling indicating a request for first data or analytics; and
transmitting a second signaling indicating the first data or analytics based at least in part on both internal data of a wireless communications system and external data an apparatus implementing the method has access to.

17. The method of claim 16, further comprising:
selecting one or more data sources of second data to use to satisfy the request;
transmitting, to each of the one or more data sources, a third signaling indicating a request for the second data from the data source; and
receiving a fourth signaling indicating the second data.

18. The method of claim 17, wherein the one or more data sources include at least one of a network data analytics function (NWDAF), a management data analytics management services (MDAS), an operations and management (OAM) entity, a data source internal to the wireless communication system, a data source external to the wireless communication system, a network slice instance, a network slice subnet instance, a network function (NF), a virtualization system, a data source belonging to a legal entity separate from a mobile network operator.

19. The method of claim 16, further comprising:
identifying, based at least in part on the first data or analytics, a service that can be provided; and
transmitting a third signaling indicating that the service is available for consumption.

20. A method, comprising:
transmitting a first signaling indicating a request for first data or analytics; and
receiving, from a device in a wireless communications system, a second signaling indicating the first data or analytics based at least in part on both internal data of the wireless communications system and external data the device has access to.
